(19) United States
(12) Patent Application Publication
(10) Pub. No.: US 2011/0044604 A1
(43) Pub. Date: Feb. 24, 2011

(54) METHOD AND APPARATUS TO PROVIDE A PHYSICAL STIMULUS TO A USER, TRIGGERED BY A MOTION DETECTION IN A VIDEO STREAM

(75) Inventors: Dirk Brokken, Eindhoven (NL); Ralph Braspenning, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/920,874

(22) PCT Filed: Mar. 4, 2009
(86) PCT No.: PCT/IB2009/050873

§ 371 Date: Nov. 12, 2010

(30) Foreign Application Priority Data
Mar. 10, 2008 (EP) 08152539.6

(51) Int. Cl. H04N 9/80

(52) U.S. Cl. 386/239; 386/E09.011

(57) ABSTRACT

An audio stream (14) and video stream (12) from a conventional audiovisual source (10) are processed by processor (20). A motion processor (30) establishes at least one motion feature and outputs it to the stimulus controller (32) which generates a stimulus in stimulus generator (34). The stimulus generator (34) may be a Galvanic Vestibular Stimulus generator.

### FIELD OF THE INVENTION

The invention relates to a method and apparatus for processing a video signal.

### BACKGROUND OF THE INVENTION

Watching audio-visual content on a conventional TV in a conventional cinema or even more recently on a computer or mobile device is not a fully immersive experience. A number of attempts have been made to improve the experience for example by using an IMAX cinema. However even in such a cinema surround sound cannot fully create the illusion of “being there”.

A particular difficulty is that it is very hard to recreate the sense of acceleration.

A proposal for supplying additional stimulation in a virtual environment is set out in U.S. Pat. No. 5,762,612 which describes Galvanic Vestibular Stimulation. In this approach a stimulus is applied to regions on the head in particular at least behind the ear to stimulate the vestibular nerve to induce a state of vestibular disequilibrium which can enhance a virtual reality environment.

### SUMMARY OF THE INVENTION

According to the invention there is provided a method according to claim 1.

The inventors have realized that it is inconvenient to have to generate an additional signal for increasing the reality of an audio-visual data stream. Few if any films or television programs include additional streams beyond the conventional video and audio streams. Moreover few games programs for computers generate such additional streams either. The only exceptions are games programs for very specific devices.

By automatically generating stimulus data from a video stream of images the realism of both existing and new content can be enhanced.

Thus this approach re-creates physical stimuli that can be applied to the human body or the environment based on an arbitrary audio-visual stream. No special audio-visual data is required.

The motion data may be extracted by:

estimating the dominant motion of the scene by calculating motion data of each of a plurality of blocks of pixels

analyzing the distribution of the motion data; and

if there is a dominant peak in the distribution of motion data identifying the motion of that peak as the motion feature.

Another approach to extracting motion data includes motion segmenting the foreground from the background and calculating the respective motion of foreground and background as the motion feature.

The non audio-visual stimulus may be a Galvanic Vestibular Stimulus. This approach enhances the user experience without requiring excessive sensors and apparatus. Indeed Galvanic Vestibular Stimulus generators may be incorporated into a headset.

Alternatively the non audio-visual stimulus may be tactile stimulation of the skin of the user.

A yet further alternative for the non audio-visual stimulus is applying a non audio-visual stimulus including physically moving the user's body or part thereof.

### BRIEF DESCRIPTION OF THE DRAWINGS

For a better understanding of the invention embodiments will now be described purely by way of example with reference to the accompanying drawings in which:

FIG. 1 shows a first embodiment of apparatus according to the invention;

FIG. 2 shows a galvanic vestibular stimulation unit used in the FIG. 1 arrangement;

FIG. 3 shows a second embodiment of apparatus according to the invention;

FIG. 4 shows a first embodiment of a method used to extract the motion features; and

FIG. 5 shows a further embodiment of a method used to extract the motion features.

The drawings are schematic and not to scale. Like or similar components are given the same reference numerals in different figures and the description relating thereto is not necessarily repeated.

### DETAILED DESCRIPTION OF THE EMBODIMENTS

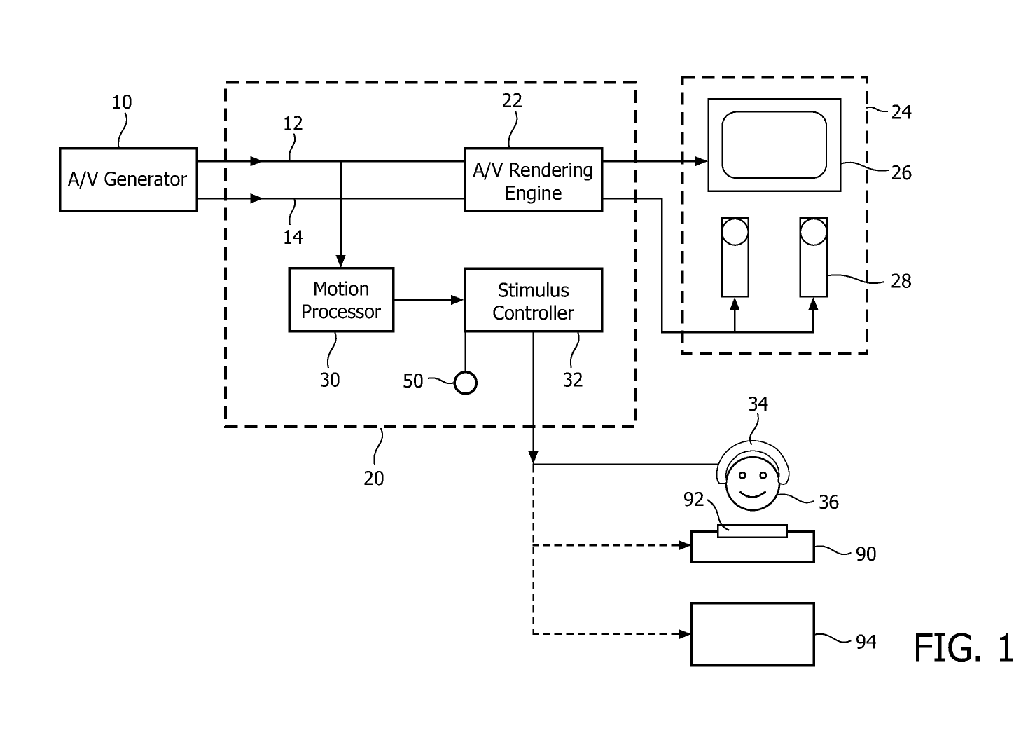

Referring to FIG. 1 a first embodiment of the invention includes an audio-visual generator 10 that supplies audio-visual content including a video stream 12 and one or more audio streams 14. The audio-visual generator may be a computer a DVD player or any suitable source of audio visual data. Note in this case that the term “video stream” 12 is used in its strict sense to mean the video data i.e. the sequence of images and does not include the audio stream 14. Of course the audio and video streams may be mixed and transmitted as a single data stream or transmitted separately as required in any particular application.

An audio-visual processor 20 accepts the audio and video streams 12,14. It includes an audio-visual rendering engine 22 which accepts the audio and video streams 12 14 and outputs them on output apparatus 24 here a computer monitor 26 and loudspeakers 28. Alternatively the output apparatus 24 could be for example a television set with integrated speakers.

The video stream 12 is also fed into a motion processor 30 which extracts motion information in the form of a motion feature from the sequence of images represented by the video stream. Typically the motion feature will relate to the dominant motion represented in the image and/or the motion of the foreground. Further details are discussed below.

The motion processor 30 is connected to a stimulus controller 32 which in turn is connected to a stimulus generator 34. The stimulus controller is arranged to convent the motion feature into a stimulus signal which is then fed to the stimulus generator 34 which in use stimulates user 36. The output of the stimulus controller 34 is thus a control signal adapted to control a stimulus generator 34 to apply a non-audio-visual physical stimulus to a user.

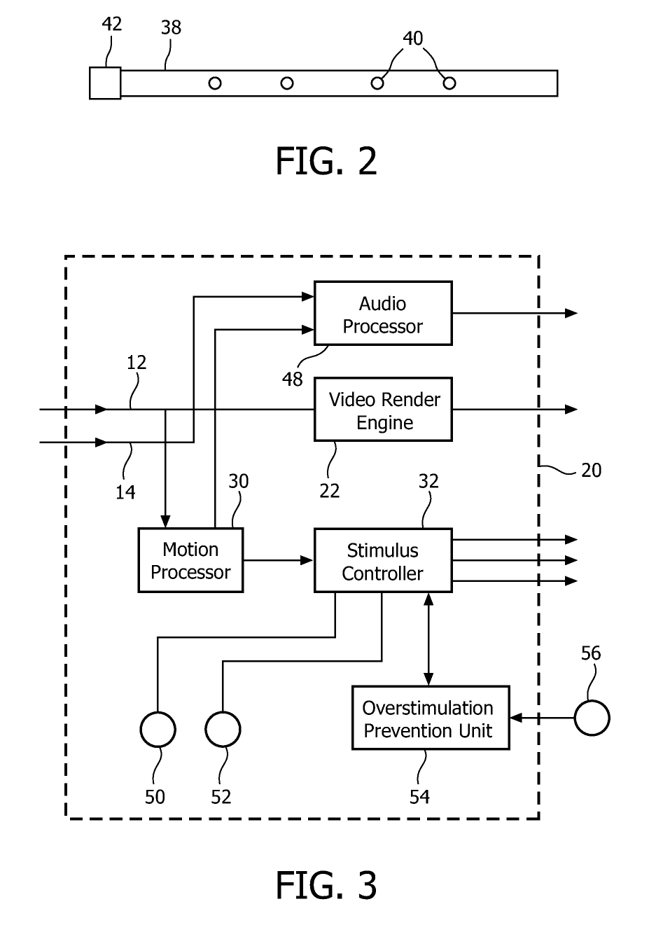

In the embodiment the stimulus generator is a Galvanic Vestibular Stimulus (GVS) generator similar to that set out in U.S. Pat. No. 5,762,612. Referring to FIG. 2 this generator includes flexible conductive patches 40 integrated into head strap 38 that may be fastened around the users head from the forehead and over the ears being fastened behind the neck by fastener 42. Alternatively a headphone could be used for this purpose. GVS offers a relatively simple way to create a sense of acceleration by electrostimulation of the users head behind the ears targeting the vestibular nerve. In this way the user can simply remain in the position he was (sitting standing lying down) and still experience the sense of acceleration associated with the video-scene.

An alternative embodiment illustrated in FIG. 3 provides further features as follows. Note that some or all of these additional features can be provided separately.

Firstly the stimulus generator 32 has multiple outputs for driving multiple stimulus generators. In general these may be of different types though it is not excluded that some or all of the stimulus generators are of the same type.

In the FIG. 3 embodiment a “strength” control 52 is provided i.e. a means for the user to select the ‘strength’ of the stimulus. This allows the user can select the magnitude or ‘volume’ of stimulation. This can also include a selection of strength for each of a number of stimulation directions or channels. The strength control 52 may be connected to the stimulus controller 32 analysis of the content of the scene being displayed (e.g. direct mapping for an action car chase reverse mapping for suspense settings and random mapping for horror scenes.)

A further refinement is an ‘over-stimulation’ prevention unit 54 for automatic regulation of the stimulation magnitude. This may be based on user adjustable limits of the stimulus to the user or sensors 56 that gather physical or psycho-physiological measurements reflecting the bodily and/or mental state of the user.

In this embodiment the movement detected from the video stream is applied to change or direct the audio stream associated with it to strengthen the sensation of movement using multi-speaker setups or intelligent audio rendering algorithms. The movement from the video signal could also be used to artificially create more audio channels.

It will be appreciated that there are a number of suitable stimulus generators 34 that may be used and these may be used with either any embodiment. These can be used in addition to other stimulus generators 34 or on their own.

Rendering the motion feature to enhance the experience can be performed either by physical stimulation of the user or by changing the (room) environment. One or more such stimulus generators may be used as required. These can be controlled by stimulus controller 32 under the control of a selection control 50.

One alternative stimulus generator 34 includes at least one mechanical actuator 62 built into a body-contact object 90. In use the body contact object is brought into contact with the user's skin and the mechanical actuator(s) 92 generate or generates tactile stimulation. Suitable body-contact objects include clothing and furniture.

A further alternative stimulus generator 34 includes a driver 94 arranged to move or tilt the ground on which the user is sitting or standing or alternatively or additionally furniture or other large objects. This type of stimulus generator realizes actual physical movement of the body.

Alternatively (or additionally) the movement detected in the video stream could also be used to change the environment by using for instance one of the following options.

A further alternative stimulus generator 34 is a lighting controller arranged to adapt lighting in the room or on the TV (Ambilight) based on the movement feature. This is particularly suitable when the movement feature relates to moving lighting patterns.

A yet further alternative stimulus generator 34 is a wind blower or fans that enhance the movement sensation by simulating air movement congruent to the movement in the video stream.

Another way to strengthen the illusion of acceleration could be to physically move (translate or rotate the image being displayed in front of the user). This could be performed by moving the complete display using mechanical actuation in the display mount or foot. For projection displays small adjustments in the optical pathway (preferably using dedicated actuators to move optical components) could be used to move or warp the projected image.

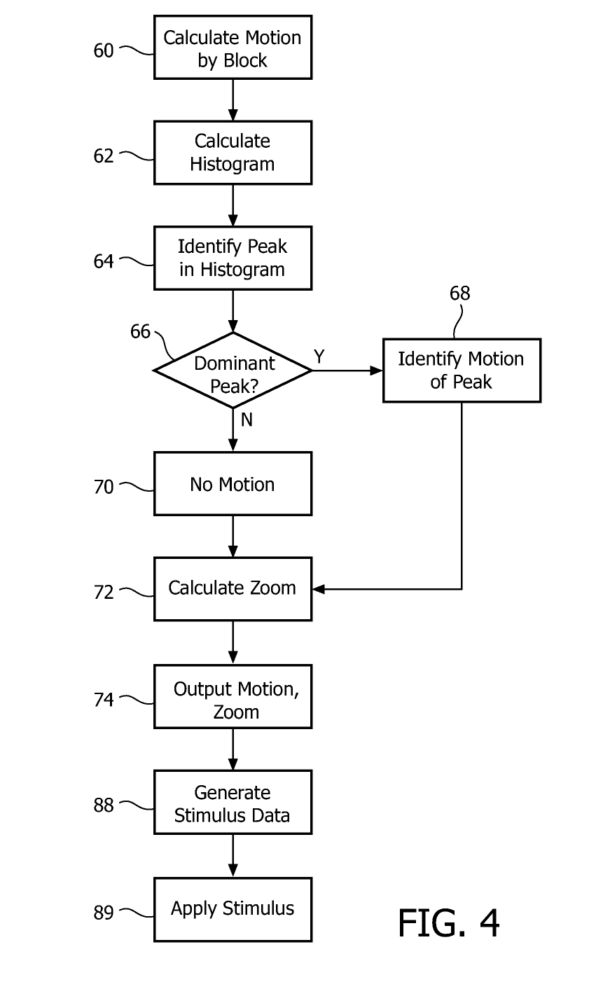

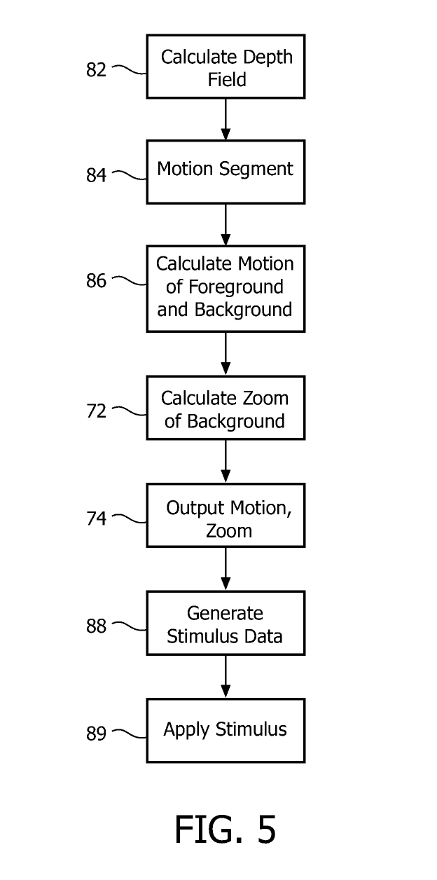

The operation of the motion processor 30 will now be discussed in more detail with reference to FIGS. 4 and 5.

In the first approach the motion processor 30 is arranged to extract the dominant translational motion from the video i.e. from the sequence of images represented by the video stream. This may be done from the stream directly or by rendering the images of the stream and processing those.

The dominant translational motion is not necessarily the motion of the camera. It is the motion of the largest object apparent in the scene. This can be the background in which case it is equal to the camera motion or it can be the motion of a large foreground object.

A first embodiment of a suitable method uses integral projections a cost effective method to achieve extraction of the dominant motion. Suitable methods are set out in D. Robinson and P. Milanfar “Fast Local and Global Projection-Based Methods for Affine Motion Estimation” Journal of Mathematical Imaging and Vision vol. 18 no. 1 pp. 35-54 2003 and A. J. Crawford et al. “Gradient based dominant motion estimation with integral projections for real time video stabilization” Proceeding of the ICIP vol 5 2004 pp. 3371-3374.

The drawback of these methods however is that when multiple objects with different motions are present in the scene they cannot single out one dominant motion because of the integral operation involved. Often the estimated motion is a mix of the motions present in the scene. Hence in such cases these methods tend to produce inaccurate results. Besides translational motions these methods can also be used to estimate zooming motion.

Accordingly to overcome these problems in a second embodiment an efficient local true motion estimation algorithm is used. A suitable three-dimensional recursive search (3DRS) algorithm is described G. de Haan and P. Biezen “Sub-pixel motion estimation with 3-D recursive search block-matching” Signal Processing: Image Communication 6 pp. 229-239 1994.

This method typically produces a motion field per block of pixels in the image. The dominant motion can be found by analysis of the histogram of the estimated motion field. In particular we propose to use the dominant peak of the histogram as the dominant motion. Further analysis of the histogram can indicate if this peak truly is the dominant motion or is merely one of many different motions. This can be used for fallback mechanisms switching back to zero estimated dominant motion when there is not one clear peak in the histogram.

FIG. 4 is a schematic flow diagram of this method. Firstly the motion of each block of pixels between frames is calculated 60 from the video data stream 12. Then the motion is divided into a plurality of “bins” i.e. ranges of motion and the number of blocks with a calculated motion in each bin is determined 62. The relationship of number of blocks and bins may be thought of as a histogram though the histogram will not normally be plotted graphically.

Next peaks in the histogram are identified 64. If there is a single dominant peak the motion of the dominant peak is identified 68 as the motion feature.

Otherwise if no dominant peak can be identified no motion feature is identified (step 70).

Clear zooming motion in the scene will result in a flat histogram. Although in principle the parameters describing the zoom (zooming speed) could be estimated from the histogram we propose to use a more robust method for this. This method estimates a number possible parameter sets from the motion field to finally obtain one robust estimate of the zoom parameters as set out in G. de Haan and P. W. A. C. Biezen “An efficient true-motion estimator using candidate vectors from a parametric motion model” IEEE tr. on Circ. and Syst. for Video Techn. Vol. 8 no. 1 Mar. 1998 pp. 85-91. The estimated dominant translational motion represents the left-right and up-down movements whereas the zoom parameters represent the forward-backward movements. Hence together they constitute the 3D motion information used for the stimulation. The method used for estimating the zoom parameters can also be used for estimating the rotation parameters. However in common video material or gaming content rotation around the optical axis occurs a lot less frequent than pan and zoom.

Thus after calculating the translational motion the zoom is calculated (step 72) and the zoom and translational motion are output (step 74) as the motion features.

After identifying the motion features the stimulus data can be generated (step 88) and applied to the user (step 89).

A further set of embodiments is not based on estimating the dominant motion in the scene but instead estimating the relative motion of the foreground object compared to the background. This produces proper results for both a stationary camera and a camera tracking the foreground object as opposed to estimating the dominant motion. In case the camera is stationary and the foreground object is moving both methods would result in the motion of the foreground object (assuming for the moment the foreground object is the dominant object in the scene). However when the camera tracks the foreground object the dominant motion would become zero in this case while the relative motion of the foreground object remains the foreground motion.

To find the foreground object some form of segmentation is required. In general segmentation is a very hard problem. However the inventors have realized that in this case motion-based segmentation is sufficient since that is the quantity of interest (there is no need to segment a stationary foreground object from a stationary background). In other words what is required is to identify the pixels of a moving object which is considerably easier than identifying the foreground.

Analysis of the estimated depth field will indicate the foreground and the background object. A simple comparison of their respective motion will yield the relative motion of the foreground object to the background. The method can deal with a translational foreground object while the background is zooming. Hence additionally the estimated zoom parameters of the background could be used to obtain a full set of 3D motion parameters for the stimulation.

Thus referring to FIG. 5 firstly the depth field is calculated (step 82). Motion segmentation then takes place (step 84) to identify the foreground and background and the motion of foreground and background is then calculated as the motion features (step 86). Background zoom is then calculated (step 70) and the motion features output (step 72).

With a stationary camera if the dominant object is the foreground the dominant motion will be the foreground motion and this is the dominant motion output as the motion feature. In contrast if the background is the dominant feature of the image the dominant motion is zero but the foreground object still moves relative to the background so the method of FIG. 5 will still output an appropriate motion feature even where the method of FIG. 4 would output zero as the dominant motion.

Similarly if the camera is following the foreground object then if the foreground object is the dominant object then the dominant motion will still be zero. In this case however the foreground still moves with respect to the background so the approach of FIG. 5 still outputs a motion feature where again the approach of FIG. 4 would not. If the background is dominant then the dominant motion approach of FIG. 4 would give the opposite motion to the motion of the foreground whereas the approach of FIG. 5 continues to give the motion of the foreground with respect to the background.

Thus in many situations the FIG. 5 approach can give a consistent motion feature output.

Finally to improve the motion perception of the user temporal post-processing or filtering can be applied to the estimated motion parameters. For instance an adaptive exponential smoothing of the estimated parameters in time would yield more stable parameters.

The processing sketched above will result in an extracted motion feature (or more than one motion feature) which represents an estimate of movement in the media stream.

The stimulus controller 32 maps the detected motion feature which may represent the user or the room onto its output in one of a number of ways. This may be user controllable using selection control 50 connected to the stimulus controller.

One approach is direct mapping of the detected background movement onto the user or environment so that the user experiences the camera movement (the user is a bystander of the action).

Alternatively the stimulus controller may directly map the detected main object movement onto the user or environment so that the users experiences the motion of the main object seen in the video.

Alternatively either of the above may be reversely mapped for a specially enhanced feeling of the movement.

To create a feeling of chaos or fear random mapping of the movement may be used to trigger a sense of disorientation as can be related to an explosion scene car crash or other violent event in the stream.

The above approach can be applied to any video-screen that allows rendering full-motion video. This includes television sets computer monitors either for gaming or virtual reality or mobile movie-players such as mobile phones mp3/video players, portable consoles and any similar device.

The above embodiments are not limiting and those skilled in the art will realize that many variations are possible. The reference numbers are provided to assist in understanding and are not limiting.

The apparatus may be implemented in software hardware or a combination of software and hardware. The methods may be carried out in any suitable apparatus not merely the apparatus described above.

The features of the claims may be combined in any combination not merely those expressly set out in the claims.

1. A method for reproducing a video data stream representing a sequence of images for a user the method comprising:
extracting at least one motion feature representing motion from the video data stream (12); and
generating (88) stimulus data from the motion feature; and
applying (89) a non audio-visual physical stimulus to a user (36) based on the stimulus data.

2. A method according to claim 1 wherein the step of extracting a motion feature comprises
estimating the dominant motion of the scene by calculating (60) motion data of each of a plurality of blocks of pixels
analyzing (62,64) the distribution of the motion data; and
if there is a dominant peak in the distribution of motion data identifying (68) the motion of that peak as a motion feature.

3. A method according to claim 1 wherein the step of extracting a motion feature comprises:
motion segmenting (84) the foreground from the background; and
calculating (86) the respective motion of foreground and background as a motion feature.

4. A method according to claim 1 wherein the step of applying (89) a non audio-visual stimulus applies a Galvanic Vestibular Stimulus to the user.

5. A method according to claim 1 wherein the step of applying (89) a non audio-visual stimulus includes applying a tactile stimulation of the skin of the user.

6. A method according to claim 1 wherein applying (89) a non audio-visual stimulus includes physically moving the user's body or part thereof.

7. A method according to claim 1 wherein the video data stream (12) is accompanied by an audio stream (14) further comprising:
receiving the audio stream and the extracted motion data;
modifying the audio data in the audio stream based on the extracted motion data; and
outputting the modified audio data through an audio reproduction unit.

8. A computer program product arranged to enable a computer connected to a stimulus generator for applying a non audio-visual stimulus to a user to carry out a method according to claim 1.

9. Apparatus for reproducing a video data stream representing a sequence of images for a user comprising:
a motion processor (30) arranged to extract at least one motion feature representing motion from the video data stream
a stimulus generator (34) arranged to provide a non-audiovisual stimulus; wherein the motion processor (30) is arranged to drive the stimulus generator based on the extracted motion feature.

10. Apparatus according to claim 9 wherein the stimulus generator (34) is a Galvanic Vestibular stimulus generator integrated into a headphone.

11. Apparatus according to claim 9 wherein the stimulus generator (34) includes at least one mechanical actuator (62) built into a body-contact object (60) for applying a tactile stimulation of the skin of the user.

12. Apparatus according to claim 9 wherein the stimulus generator (34) includes an actuator (64) arranged to physically move a ground surface or furniture for applying a non audio-visual stimulus includes physically moving the user's body or part thereof.

13. Apparatus according to claim 9 wherein the motion processor is arranged to estimate the dominant motion of the scene by calculating motion data of each of a plurality of blocks of pixels to analyze the distribution of the motion data; and if there is a dominant peak in the distribution of motion data to identify the motion of that peak as the motion feature.

14. Apparatus according to claim 9 wherein the motion processor (30) is arranged to motion segment the foreground from the background and to calculate the respective motion of foreground and background as the motion feature.

15. Apparatus according to claim 9 further comprising:
an audio processor (48) arranged to receive an audio data stream and to receive the extracted motion feature from the effects processor and to modify the received audio data in the audio stream based on the extracted motion feature; and
an audio reproduction unit for outputting the modified audio data.
